(19) United States
(12) Patent Application Publication
(10) Pub. No.: US 2023/0264550 A1
(43) Pub. Date: Aug. 24, 2023

(54) SEAL ASSEMBLY FOR A VEHICLE WINDOW ARRANGED ON A VEHICLE

(71) Applicant: AUDI AG, Ingolstadt (DE)

(72) Inventor: Richard PICKL, Denkendorf (DE)

(73) Assignee: AUDI AG, Ingolstadt (DE)

(21) Appl. No.: 18/007,250

(22) PCT Filed: Jun. 22, 2021
(86) PCT No.: PCT/EP2021/066944

§ 371 Date: Jan. 27, 2023

(30) Foreign Application Priority Data
Aug. 20, 2020 (DE) 10 2020 121 812.5

(51) Int. Cl. B60J 10/777; B60J 10/20

(52) U.S. Cl. CPC B60J 10/777; B60J 10/20

(57) ABSTRACT

A seal assembly arranged on a vehicle window of a vehicle. The seal assembly is arranged between a first window element of the vehicle window and a second window element of the vehicle window. The second window element can be moved relative to the first window element. The seal assembly includes a first horizontal sealing portion and a second vertical sealing portion. The first horizontal sealing portion has a first cross-sectional area and the second vertical sealing portion has a second cross-sectional area. The first cross-sectional area of the first horizontal sealing portion is greater than the second cross-sectional area of the second vertical sealing portion.

### TECHNICAL FIELD

The present disclosure relates to a seal assembly for a vehicle window arranged on a vehicle, wherein the seal assembly is arranged between a first window element of the vehicle window and at least one further window element of the vehicle window, which can be moved relative to the first window element, wherein the seal assembly comprises a first horizontal sealing portion and at least one second vertical sealing portion.

### BACKGROUND

DE 2 303 622 B1 discloses a combination of a seal and a first window which interact with a second window of a motor vehicle.

U.S. Patent Application Publication No. US 2011/0033667 A1 discloses a partition glass having at least two glass elements.

A seal assembly between two plane components is known from German Application Publication No. DE 10 2018 218 332 A1.

In the case of a multi-part vehicle window having a movable window element and a window element arranged immovably with respect thereto on a vehicle, at a high vehicle speed (in particular at speeds greater than 200 km/h) a negative pressure, which pulls the window elements outwards, occurs in the region of the window elements. As a result, “mounting/sealing” the movable window element is difficult. This problem can be at least partially counteracted by a seal arranged between the two window elements and having a relatively large cross section. However, this results in an obscured view, in particular in the region of a vehicle pillar.

### SUMMARY OF INVENTION

The object underlying the described embodiments of the invention is seen in providing a seal assembly for a multi-part vehicle window which, on the one hand, enables improved mounting/sealing of window elements at high speeds, and on the other hand does not additionally restrict the view.

This object is achieved by a seal assembly for a vehicle window arranged on a vehicle and having the features of claim 1 and by a vehicle having the features of claim 10. Advantageous embodiments having useful further developments are specified in the dependent claims.

Proposed therefore is a seal assembly for a vehicle window arranged on a vehicle, wherein the seal assembly is arranged between a first window element of the vehicle window and at least one further window element of the vehicle window, which can be moved relative to the first window element, wherein the seal assembly comprises a first horizontal sealing portion and at least one second vertical sealing portion. It is provided that the first horizontal sealing portion has a larger cross-sectional area than the second vertical sealing portion.

In connection with the present application, horizontal is understood to mean that the respective sealing portion extends along an imaginary horizontal straight line, in particular from the front to the rear. In this case, minor deviations or inclinations or curvatures relative to an imaginary horizontal straight line should also fall within the selected term “horizontal”. In particular, the horizontal sealing portion should also comprise an intersecting at least in portions of the imaginary horizontal straight line at an acute angle, wherein the angle is, for example, less than 20°, in particular less than 10°. The term “horizontal” can also be understood to mean that the horizontal sealing portion substantially follows a contour line of a vehicle roof.

In connection with the present application, it is understood that the relevant sealing portion extends along an imaginary vertical straight line, in particular from top to bottom. In this case, minor deviations or inclinations or curvatures relative to an imaginary vertical straight line should also fall within the selected term “vertical”. In particular, the vertical sealing portion should also comprise a cutting/intersecting with the imaginary vertical straight line at an acute angle at least in portions, wherein the angle is, for example, less than 40°, in particular less than 20°. The term “vertical” can also be understood to mean that the horizontal sealing portion substantially follows an incline of a windshield or an incline of a frame element, such as an A pillar or front door frame of a vehicle body.

A variable seal and window element guide between the first window element and the further window element is made possible by sealing portions with different cross-sectional areas.

A larger cross-sectional area results in an enlarged “mounting region” which enables improved window element guidance. In this case, the second sealing portion can serve as a simple seal which, due to the smaller cross-sectional area, avoids additional restricted visibility.

Further, the first sealing portion may be connected to the second sealing portion.

The first sealing portion and the second sealing portion can be configured to receive at least one edge region of the first window element and one edge region of the further window element.

In this case, the first sealing portion and the second sealing portion can comprise a contact portion that abuts against or can be brought into contact with the further window element.

The contact portion of the first sealing portion can have a contact surface that is different from, in particular larger than, the contact portion of the second sealing portion. A larger edge region of the further window element can be accommodated by the larger contact surface of the first sealing portion. This makes it possible to improve the guiding of the window element and sealing, in particular at high speeds.

The further window element can be movable relative to the first window element, in particular away from the first sealing portion and the second sealing portion or can be moved towards the latter.

The first window element and the further window element can be oriented at an angle to one another so that a kink is formed in the region of the seal assembly.

The first window element and the further window element can be arranged in the region of a vehicle door of the vehicle.

In this case, the first window element can further be arranged in the region of a front vehicle pillar of the vehicle.

The above object is also achieved by a vehicle having a seal assembly for a vehicle window arranged on the vehicle as described above.

In this case, the further window element can be movably connected to a side door of the vehicle.

The further window element can be at least partially retractable in the side door.

The first window element and the further window element can thus be arranged with respect to one another in such a way that an outwardly perceptible kink on the vehicle is formed in the region of the seal assembly.

### BRIEF DESCRIPTION OF THE FIGURES

Further advantages and details of embodiments of the invention will become apparent from the following description of embodiments with reference to the figures. They show:

FIG. 1A a simplified and schematic representation of a seal assembly for a vehicle window arranged on a vehicle according to an embodiment;

FIG. 1B a simplified and schematic representation of the seal assembly according to an embodiment;

FIG. 2A a simplified and schematic sectional representation of the seal assembly according to an embodiment; and

FIG. 2B a simplified and schematic sectional representation of the seal assembly according to an embodiment.

### DETAILED DESCRIPTION OF THE FIGURES

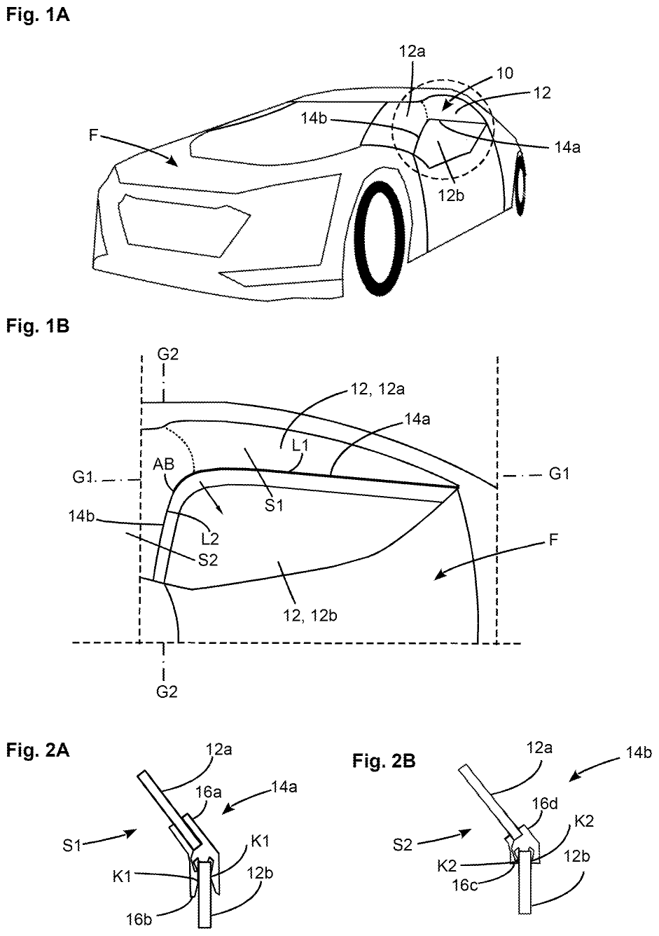

FIG. 1A and 1B show simplified and schematic representations of an embodiment of a seal assembly 10 for a vehicle window 12 arranged on a vehicle F. The seal assembly 10 is accommodated or arranged between a first window element 12a and at least one further window element 12b of the vehicle window. In the example shown in FIG. 1, two window elements 12a, 12b are shown. However, this is not limiting and the vehicle window 12 can have additional window elements. The seal assembly 10 further comprises a first sealing portion 14a and a second sealing portion 14b. The first sealing portion 14a can extend, for example, substantially horizontally between the first window element 12a and the further window element 12b, as shown in FIG. 1A and FIG. 1B. The second sealing portion 14b can extend substantially vertically to the first sealing portion 14a between the first window element 12a and the further window element 12b and are further located in the region of a vehicle pillar (not shown in FIG. 1A and FIG. 1B) of the vehicle F. Further embodiments for the sealing portions 14a, 14b are possible and the example shown is not limiting. The region illustrated in FIG. 1A by the dashed circle is shown enlarged in FIG. 1B.

Here, the first sealing portion 14a has a cross-sectional area that is different from the second sealing portion 14b. This is illustrated by the broader line for the first sealing portion 14a in FIG. 1B and will be described in detail later with reference to FIG. 2A and 2B. By means of the different cross-sectional areas, different sealing profiles can be realized in the respective sealing portions 14a, 14b, which sealing profiles facilitate a variable guiding of the window element.

For example, at a high speed of the vehicle F, in particular at speeds greater than 200 km/h, a negative pressure occurs which pulls the window elements 12a, 12b outwards. This makes mounting the further window element 12b in an open state more difficult, as is illustrated, for example, in FIG. 1B.

In order to counteract this effect, the first sealing portion 14a can therefore have a larger cross-sectional area than the second sealing portion 14b. A larger cross-sectional area and thus a larger “mounting region” ensures efficient guiding of the window element. Further, the cross-sectional area of the second sealing portion 14b can be smaller than that of the first sealing portion 14a, as a result of which an obscured view, especially obliquely forward in the region of the vehicle pillar of the vehicle F, is avoided.

The first sealing portion 14a may be connected to the second sealing portion. In one embodiment, this may be realized by a connection portion (not shown in FIG. 1A and FIG. 1B) that allows a continuous transition from the first sealing portion 14a to the second sealing element 14b. In another non-limiting example, the two sealing portions 14a, 14b may be contacted with one another by adhesive connection, or the like.

The first sealing portion 14a extends horizontally along a first contour line L1.

The second sealing portion 14b extends vertically along a second contour line L2. It should be noted here that the profile of the contour lines L1, L2 or of the respective sealing portions 14a, 14b does not necessarily have to be arranged exactly parallel to an indicated horizontal direction G1 or vertical direction G2. Rather, the terms “horizontal” and “vertical” are to be understood to mean that the contour lines L1, L2 can also intersect the horizontal straight line G1 or the vertical straight line G2 at an angle of inclination or run at an incline or in a curved manner at least in sections.

The first sealing portion 14a and the second sealing portion 14b can each accommodate at least one edge region of the first window element 12a and one edge region of the further window element 12b. Here, FIG. 2A and 2B show simplified and schematic sectional views of an embodiment of the seal assembly. FIG. 2A shows the sectional view in the first sealing portion 14a along the line marked in FIG. 1B by S1. FIG. 2B shows the sectional view in the second sealing portion 14b along the line marked in FIG. 1B by S2.

In the example shown in FIGS. 2A and 2B, the first sealing portion 14a and the second sealing portion 14b may each comprise a first sealing element 16a, 16c and at least one further sealing element 16b, 16d connected to the first sealing element 16a, 16c, which is illustrated schematically and in simplified form. The first sealing elements 16a, 16c and the further sealing elements 16b, 16c can further comprise sealing lips which are arranged such that they can accommodate the edge region of the first window element 12a and of the further window element 12b between them. However, this embodiment is not limiting and further embodiments for the first sealing portion 14a and the second sealing portion 14b are possible.

In one embodiment, the first sealing portion 14a and the second sealing portion 14b can have a contact portion K1, K2 that abuts against or can be brought into contact with the further window element 12b.

The contact portion K1 of the first sealing portion 14a can have a contact surface that is different from, in particular larger that the contact portion K2 of the second sealing portion 14b. Due to the larger contact surface of the first sealing portion 14a, which is provided, for example, by the above-described sealing elements 16a, 16b of the first sealing portion 14a, a larger edge region of the further window element 12b can be accommodated, as shown in FIG. 2A. As a result, an efficient guiding and sealing of the window element can be facilitated even at high speeds.

In contrast, the contact portion K2 of the second sealing portion 14b can have a smaller contact surface, as shown in FIG. 2B. The above-described sealing elements 16c, 16d of the second sealing portion 14b can serve here purely for sealing. The resulting smaller cross-sectional area of the second sealing portion 14b can further avoid a restricted view in the region of the vehicle pillar.

The further window element 12b can be movable relative to the first window element 12a, in particular away from the first sealing portion 14a and the second sealing portion 14b, or can be moved towards the latter. As described above, this is shown in FIG. 1B, wherein the second window element 12b moves away from the first window element 12a and the first sealing portion 14a, which is illustrated by the arrow.

The first window element 12a and the further window element 12b can be oriented at an angle to one another so that a kink is formed in the region of the seal assembly 10.

As shown in FIG. 1A, the first window element 12a and the further window element 12b can be arranged in the region of a vehicle door of the vehicle F.

The first window element 12a can further be arranged in the region of a front vehicle pillar of the vehicle F. For example, the first window element 12a can be fixedly connected to a vehicle pillar, which is indicated in simplified form by the dotted line in FIG. 1A and FIG. 1B.

The example of a vehicle F shown in FIG. 1A with a seal assembly 10 described above is not limiting. The vehicle F can be of varied design and have four doors, for example.

The further window element 12b is movably connected to a side door of the vehicle F.

Furthermore, the further window element 12b can be at least partially recessed in the side door.

The first window element 12a and the further window element 12b are arranged relative to one another in such a way that, in the region of the seal assembly 10, an outwardly perceptible kink on the vehicle F is formed.

1-13. (canceled)

14. A seal assembly for a vehicle window of a vehicle, the seal assembly comprising:
a first horizontal sealing portion having a first cross-sectional area; and
a second vertical sealing portion having a second cross-sectional area,
wherein the first cross-sectional area of the first horizontal sealing portion is greater than the second cross-sectional area of the second vertical sealing portion, and
wherein the seal assembly is disposed between a first window element of the vehicle window and a second window element of the vehicle window, the second window element being movable relative to the first window element.

15. The seal assembly according to claim 14, wherein the first sealing portion is connected to the second sealing portion.

16. The seal assembly according to claim 14, wherein the first sealing portion and the second sealing portion are each configured to receive an edge region of the first window element and an edge region of the second window element.

17. The seal assembly according to claim 16, wherein the first sealing portion and the second sealing portion each comprise a contact portion configured to engage the second window element.

18. The seal assembly according to claim 17, wherein the contact portion of the first sealing portion has a first contact surface, and the contact portion of the second sealing portion has a second contact surface, and wherein the first contact surface is larger than the second contact surface.

19. The seal assembly according to claim 14, wherein the second window element is configured to be moved relative to the first window element in a direction away from or towards the first sealing portion and the second sealing portion.

20. The seal assembly according to claim 14, wherein the first window element is oriented at an angle with respect to the second window element to define a kink in a region defined by the seal assembly.

21. The seal assembly according to claim 14, wherein the first window element and the further window element are arranged along a vehicle door of the vehicle.

22. The seal assembly according to claim 21, wherein the first window element is further arranged along vehicle front pillar of the vehicle.

23. A vehicle comprising:
a vehicle window including a first window element and a second window element; and
a seal assembly disposed between the first window element and the second window element, the seal assembly comprising a first horizontal sealing portion having a first cross-sectional area and a second vertical sealing portion having a second cross-section area,
wherein the first window element is configured to be moved relative to the second window element, and
wherein the first cross-sectional area of the first horizontal sealing portion is greater than the second cross-sectional area of the second vertical sealing portion.

24. The vehicle according to claim 23, wherein the second window element is movably connected to a side door of the vehicle.

25. The vehicle according to claim 24, wherein the second window element is at least partially retractable in the side door.

26. The vehicle according to claim 23, wherein the first window element is oriented at an angle with respect to the second window element in the region of the sealing assembly to define an outwardly perceptible kink on the vehicle.
